(19) United States
(12) Patent Application Publication
(10) Pub. No.: US 2012/0176779 A1
(43) Pub. Date: Jul. 12, 2012

(54) LUMINOUS PRODUCT STRUCTURE

(76) Inventors: Connie WANG, Irvine, CA (US); Wei Hung Yu, (US)

(21) Appl. No.: 13/004,910

(22) Filed: Jan. 12, 2011

(51) Int. Cl. F21L 4/02

(52) U.S. Cl. 362/184

(57) ABSTRACT

This invention is a luminous product structure, in particular one that takes advantage of the special design of a product's dazzling body to create a dazzling effect, making the product more attractive; it includes a casing and a luminous unit; the casing has a dazzling casing which has a series of multiangular diamond-cut dazzling bodies joined to surrounding raised strips; the luminous unit comprises of a circuit board and a luminous unit and can be fitted into inside of the casing, the aforementioned design allowing the luminous unit to glitter and, in conjunction with the multi-face light refraction special feature, effectively increasing the novelty and added-value of the product.

### BACKGROUND OF THE INVENTION

1. Field of the Invention

This invention is a kind of product illumination technology, in particular an object with luminous unit that has a casing that provides a dazzling function, increasing colored light refraction and a dazzling effect, making the product more fun.

2. Description of the Prior Art

Most ordinary luminous products have lights in the luminous body that create a luminous effect; however the light source only has light-emitting and color change functions, thus has reduced appeal to children and adults.

If a product was made available that had dazzling effect and produced different lights of light the objective of making a product more attractive would be achieved.

### SUMMARY OF THE INVENTION

This invention mainly provides a luminous product structure that creates a dazzling effect and provides an enhanced refraction and dazzling effect when used.

### BRIEF DESCRIPTION OF DRAWINGS

This invention will be better understood by referring to the accompanying drawings, wherein:

FIG. 1 is an exploded perspective view of the luminous product in the presented invention;

FIG. 2 is a perspective view of the luminous product in the present invention;

FIG. 3 is another side perspective view of the luminous product in the present invention;

FIG. 4a is a front view of the space in the casing of the present invention;

FIG. 4b is a cross sectional view, taken along line A-A of FIG. 4a;

FIG. 5 is a perspective view of the luminous product in using condition in the present invention; and

FIG. 6 is a perspective view of another actual embodiment of the luminous product in the present invention.

### DETAILED DESCRIPTION OF THE PREFERRED EMBODIMENT

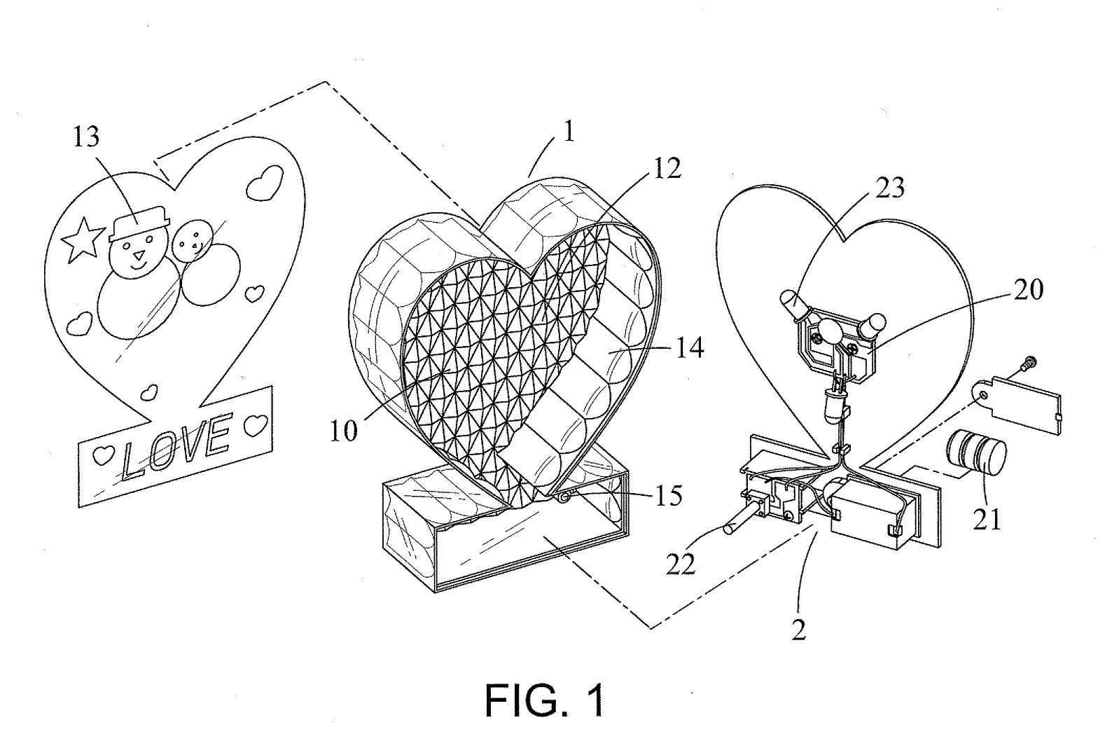

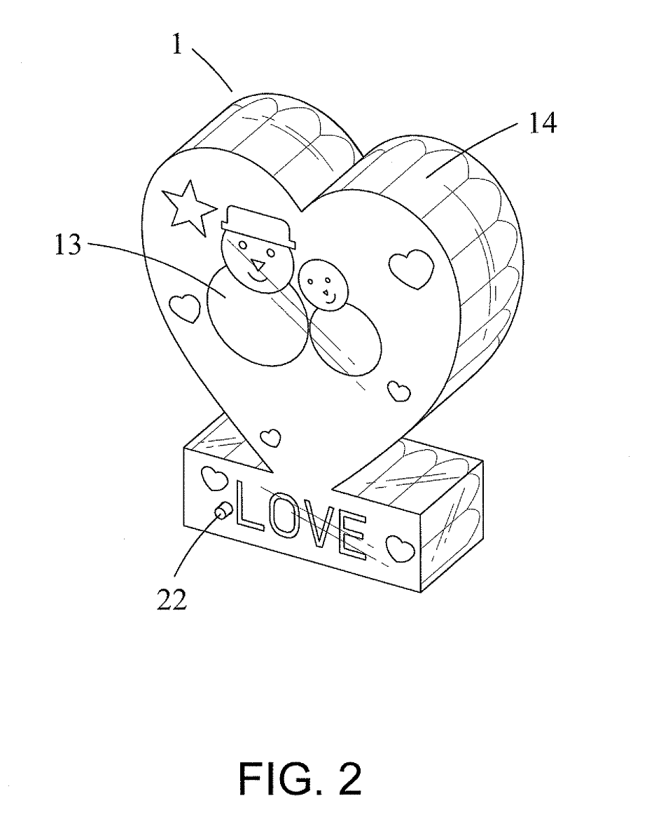

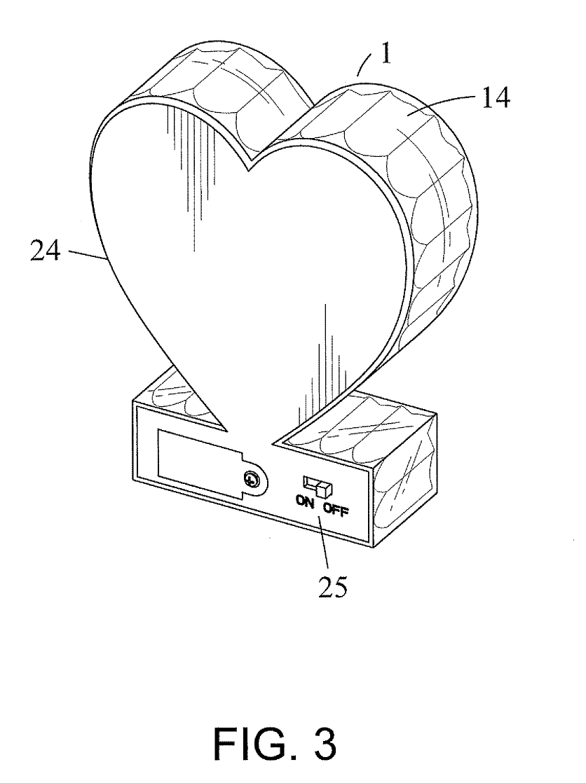

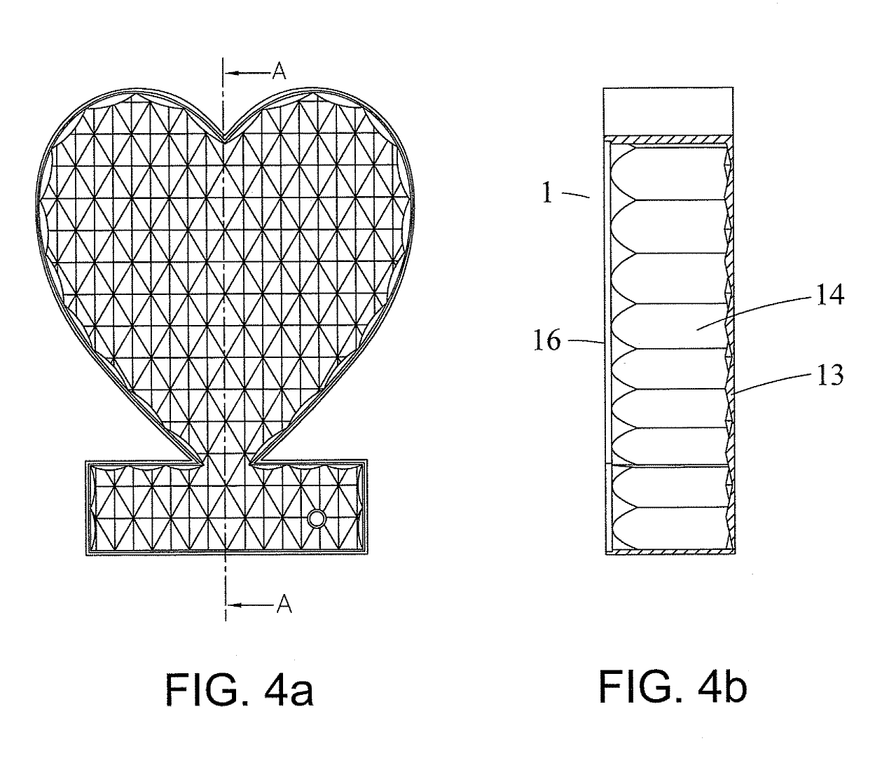

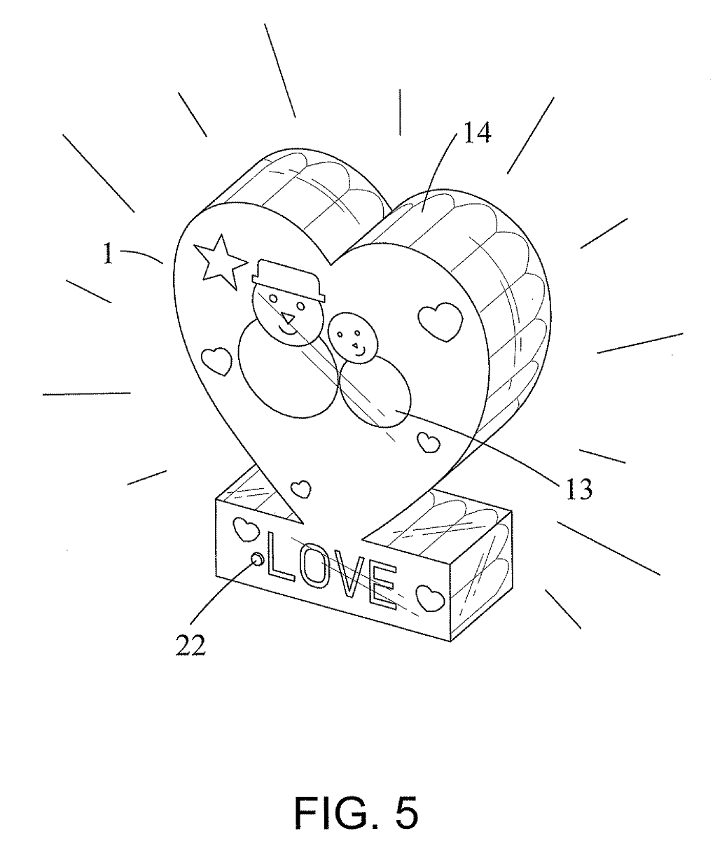

As shown in FIGS. 1˜5, a preferred embodiment of a luminous product structure in the present invention includes a casing 1 and a luminous unit 2.

For the detailed structure of the preferred embodiment of this, please refer to FIG. 1˜5. In the preferred embodiment casing 1 is made of light permeable material. Casing 1 has a space 10 and joint part 11. The surface of space 10 in casing 1 has a concave and convex pyramid light-permeable dazzling body 12 made up of polyhedron (such as rhombic, square and star diamond cut surfaces). Light from the light source is refracted by the concave and convex cones of dazzling body 12 and a dazzle effect is created. Colored patterns 13 can be stuck to casing 1 to make the casing 1 more attractive overall. The inside edge of casing 1 also form concave and convex cord band, wave or teeth shaped refractive surface 14. On casing 1 there is a hole 15 through which switch 22 can protrude for easy operation. On the outside surface of casing 1 there is also a flat surface 16 on which colored patterns 13 can be stuck on printed on.

The aforementioned luminous unit 2 has a control circuit board 20 with pre-set control method. On the control circuit board 20 there is a battery 21 that supplies power and an on/off switch 22. Control circuit board 20 has at least one micro light-emitting device 23. Light emitting device 23 can be single color or combination of multiple colors. Light emitting device 23's power source is the battery 21 on control circuit board 20 and is turned on and off using on/off switch 22. Light emitting device 23 is fitted inside the space 10 in the casing 1. Luminous unit 2 has a joint body 24 which connects to joint part 11 on casing 1, fixing luminous unit 2 in space 10 of casing 1. On the other end of joint body 24 on luminous unit 2 there is a power switch 25.

This way, the shape of the dazzling body 12 of the casing 1 can be spherical and when a dazzling effect is required from the dazzling body 12 all that is needed is to press switch 22 on the control circuit board 20 of the luminous unit 2, then battery 21 will provide power to light emitting device 23 so that the light emitting device 23 emits light. Taking advantage of the transparent and reflective properties of dazzling body 12 the whole casing 1 will produce the desired dazzling effect, being both very attractive and also having enhanced refractive dazzle.

The above explanation shows that this invention has the following advantages:

1. The dazzling body 12 of the casing 1 is made up of a number of refractive faces of different angles that refract light and create a dazzling effect.

2. The colored patterns 13 on flat surface 16 of the casing 1 increase the light source for the dazzling effect of the casing 1.

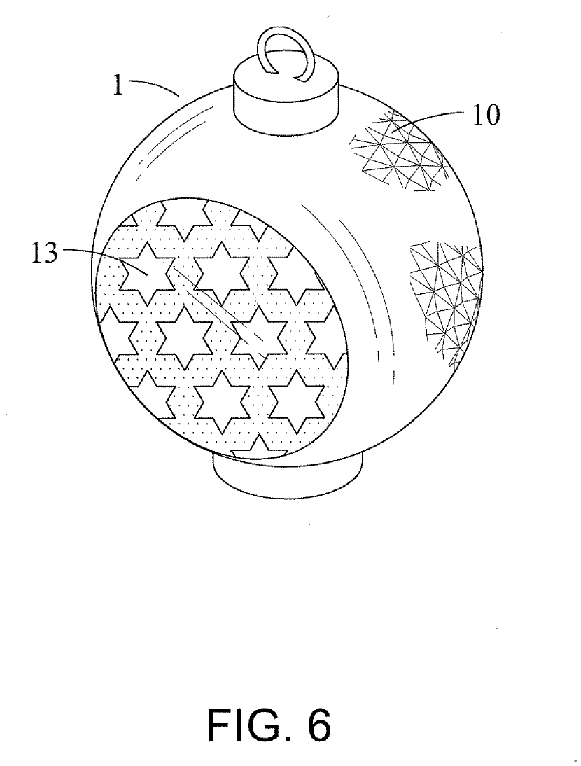

3. The casing 1 in this invention can be in another style as shown in FIG. 6.

While the preferred embodiment of the invention has been described above, it will be recognized and understood that various modifications may be made therein and the appended claims are intended to cover all such modifications that may fall within the spirit and scope of the invention.

What is claimed is:

1. A luminous product structure, including:
a casing with a space, joint part and colored pattern; inside the space there is a dazzle body on the surface and, on the outside; the colored patterns are stuck or printed on the flat surface of the casing;
a luminous unit, fixed on the joint part on the casing; this luminous body comprises of a control circuit board, battery, light-emitting device and switch, each light emitting device having more than one light-emitting diode (LED) light;
assembled together they form a luminous product with increased light refraction and dazzle.

2. A luminous product structure as claimed in claim 1, wherein the casing of which colored patterns can be stuck to increase the casing's dazzling effect.

3. A luminous product structure as claimed in claim 1, wherein the dazzling body of the casing of which can be diamond cut surfaces such as rhombic, square, star-shaped and other shapes in different sizes.

4. A luminous product structure as claimed in claim 1, wherein the light-emitting diode (LED) light in the luminous unit of which can be same color or more than one color.

5. A luminous product structure as claimed in claim 1, wherein the casing of which can be various different shapes.

6. A luminous product structure as claimed in claim 1, wherein the light emitting diode (LED) light of which can according to the effect needed be placed on the back, bottom or other place inside an object.

7. A luminous product structure as claimed in claim 2, wherein the colored patterns of which can be screen printed, pad printed, heat transfer printed or stickers.
